(19) United States
(12) Patent Application Publication
(10) Pub. No.: US 2021/0390493 A1
(43) Pub. Date: Dec. 16, 2021

(54) INTELLIGENT WORK PERFORMANCE TRANSACTION ENGINE

(71) Applicant: Facilgo, Inc., Los Altos, CA (US)

(72) Inventor: Ken MURAI, Los Altos, CA (US)

(21) Appl. No.: 17/315,193

(22) Filed: May 7, 2021

Related U.S. Application Data
(60) Provisional application No. 63/038,719, filed on Jun. 12, 2020.

(51) Int. Cl. G06Q 10/06; G06N 5/04; G06Q 10/10

(52) U.S. Cl. CPC G06Q 10/063112; G06Q 10/10; G06N 5/04

(57) ABSTRACT

A computerized property inspection and work order creation system is disclosed, where the system automatically provides proposed work performance transactions to the user based upon prior inspections, work orders, proposed work performance transactions, and executed work performance transactions. The work performance transactions can include sending quote requests or orders to suppliers or sub-contractors, creating and sending work orders to staff members for completion, generating charges to property owners, and updating budgets based upon the inspection and suggested items and services. The proposed work performance transactions optionally are provided by an artificial intelligence engine.

### PRIORITY CLAIM

This application claims priority to U.S. Provisional Patent Application No. 63/038,719, filed on Jun. 12, 2020, and titled “System and Methods for Computing Device Based Inspections or Work Orders with Next Step Transactions and Resident Chargebacks,” which is incorporated by reference herein.

### FIELD OF THE INVENTION

A computerized property inspection and work order system is disclosed that automatically provides proposed work performance transactions based upon prior inspections, work orders, proposed work performance transactions, and executed work performance transactions, optionally using an artificial intelligence engine.

### BACKGROUND OF THE INVENTION

Inspections of property are regularly performed to check on the completion of construction jobs or to inspect the state of a physical asset. The latter might be performed to determine the state of an apartment unit after a tenant moves out, as part of a due diligence process on a property or capital asset that is under consideration for purchase, as part of a periodic check of the asset, etc. These inspections typically are performed by an inspector using a paper template configured for the job at hand, where the inspector checks off items on his template, records the status and condition of various items, takes notes, records measurements, and fills out other information related to his or her task.

More recently, the prior art has included rudimentary software applications for the inspection process. These prior art software applications utilize this same list-based approach that mimics the paper-based process. Inspections are created from templates and are filled out with notes, ratings, checkboxes, photos, videos, etc. Some prior art software inspection applications allow the inspector to input text by transcribing his or her voice input and can generate email work requests based upon the input and the inspection line items from the templates.

Notably, prior art software inspection applications do not have the capability or functionality to suggest the tasks that should be performed (e.g., work order creation) or to suggest the products or services that should be purchased (e.g., order or quote request creation), nor do the prior art software applications generate and implement such transactions.

In another aspect of the prior art, professionals typically create work orders using a paper template or a software version of a paper template that assists a user in creating a work order. Prior art software work order applications do not have the capability or functionality to suggest tasks or items that should be added to a work order or to suggest the products or services that should be purchased, nor do the prior art software applications generate and implement such transactions.

What is needed is an intelligent inspection and work order system that receives input from an inspector and relevant persons in relation to an inspection or from a profession in relation to a work order creation and generates recommended work performance transactions to be executed and to take steps to implement those transactions when instructed to do so.

### BRIEF SUMMARY OF THE INVENTION

A computerized property inspection and work order creation system is disclosed, where the system automatically provides proposed work performance transactions to the user based upon prior inspections, work orders, proposed work performance transactions, and executed work performance transactions. The work performance transactions can include sending quote requests or orders to suppliers or sub-contractors, creating and sending work orders to staff members for completion, generating charges to property owners, and updating budgets based upon the inspection and suggested items and services. The proposed work performance transactions optionally are provided by an artificial intelligence engine.

The resulting inspection/work order with work performance transaction makes it possible to enforce standards and create greater efficiencies through the inspection process. It also creates efficiencies and reduces cost by enforcing the electronic purchasing of products and services at pre-negotiated prices from specific suppliers, if defined.

The embodiments described herein comprise a novel approach to performing inspections, assessing work orders, and performing subsequent actions in response to the inspections or work orders.

In one embodiment, a method of automating transactions for work performance on a building comprises creating, by a computer system, a template; customizing, using the computer system, the template for the building to generate a customized template; populating, by the computer system, the customized template with input data provided by a user for the building; recommending, by the computer system, a work performance transaction based on the input data; and executing, using the computer system, the work performance transaction.

In another embodiment, a method of automating transactions for work performance on a building, comprises obtaining, by a computing device, images or video of a building; obtaining, by the computing device, notes from a user regarding the images or video; populating, by the computing device, a template using the notes; recommending, by the computing device, a work performance transaction in response to the notes; and executing, by the computing device, at least part of the work performance transaction.

In another embodiment, a computing device for identifying automating a work performance transactions for a building comprises a processing unit; an input device; and non-volatile storage containing a template for a building and instructions to be executed by the processing unit to perform the following steps: populate the template with input data received with the input device from a user; identify a work performance transaction based on the input data; and execute the work performance transaction.

### BRIEF DESCRIPTION OF THE DRAWINGS

These and other features of the invention will be more readily understood upon consideration of the attached drawings and of the following detailed description of those drawings and the disclosed embodiments of the invention.

FIG. 1A depicts an exemplary computer system for performing the functionality described herein.

FIG. 1B depicts exemplary components of a computing device used in the computer system of FIG. 1A.

FIG. 2 depicts an intelligent work performance transaction recommendation method performed by the computer system of FIG. 1A.

FIGS. 3A and 3B illustrate variations of the intelligent work performance transaction recommendation method of FIG. 2 for an improved inspection process.

FIG. 4 illustrates a variation of the intelligent work performance transaction recommendation method of FIG. 2 for an improved work order process.

FIG. 5 depicts software engines contained within the computer system of FIG. 1A and the computing device of FIG. 1B.

FIG. 6 shows a screenshot of an exemplary user interface in a computing device for creating an inspection list item with a mapped work performance according to the methods of FIG. 2, 3A, or 3B.

FIG. 7 shows a screenshot of an exemplary user interface in a computing device for performing an inspection in a video centric mode according to the methods of FIG. 2, 3A, or 3B.

FIG. 8 shows a screenshot of an exemplary user interface in a computing device for performing the inspection in a list mode according to the methods of FIG. 2, 3A, or 3B.

FIG. 9 shows a screenshot of an exemplary user interface in a computing device for performing a work order in a list mode according to the methods of FIG. 2 or 4.

FIG. 10 depicts a screenshot of an exemplary user interface in a computing device for creating a mapped work performance transaction within a work order mode during an inspection according to the methods of FIG. 2, 3A, 3B, or 4.

FIG. 11 depicts a screenshot of an exemplary user interface in a computing device for executing one or more work performances for a work order following an inspection according to the methods of FIG. 2, 3A, 3B, or 4.

FIG. 12 depicts a screenshot of an exemplary user interface in a computing device for creating a mapped work performance transaction within a quote request mode during an inspection according to the methods of FIG. 2, 3A, or 3B.

FIG. 13 depicts a screenshot of an exemplary user interface in a computing device for executing one or more work performances for a quote request following an inspection according to the methods of FIG. 2, 3A, or 3B.

FIG. 14 depicts a screenshot of an exemplary user interface in a computing device for creating a mapped work performance transaction within a catalog order mode during an inspection according to the methods of FIG. 2, 3A, or 3B.

FIG. 15 depicts a screenshot of an exemplary user interface in a computing device for executing one or more work performances for a catalog order following an inspection according to the methods of FIG. 2, 3A, or 3B.

FIG. 16 depicts a screenshot of an exemplary user interface in a computing device for creating a mapped work performance transaction within a non-catalog order mode during an inspection according to the methods of FIG. 2, 3A, or 3B.

FIG. 17 depicts a screenshot of an exemplary user interface in a computing device for executing one or more work performances for a non-catalog order following an inspection according to the methods of FIG. 2, 3A, or 3B.

FIG. 18 depicts a screenshot of an exemplary user interface in a computing device for creating a mapped work performance transaction within a budget mode during an inspection according to the methods of FIG. 2, 3A, or 3B.

FIG. 19 depicts a screenshot of an exemplary user interface in a computing device for executing one or more work performances for a budget following an inspection according to the methods of FIG. 2, 3A, or 3B.

FIG. 20 depicts an exemplary database schema for use in the embodiments described herein.

### DETAILED DESCRIPTION OF THE INVENTION

In this application, the term “inspector” refers to an individual who performs a building or property inspection with the assistance of the computer system described herein. The term “contractor” refers to an individual who inputs a work order with the assistance of the computer system described herein. The term “professional” refers to an inspector or a contractor. The term “owner” refers to the individual who owns or manages the building or property that is the subject of the inspection. The term “coordinator” refers to an individual who performs administrative tasks in conjunction with the inspection. The term “supplier” refers to an individual who offers a product or service for sale that is relevant to the inspection or to work that will follow the inspection. The term “user” refers to any individual who accesses data in an embodiment of the computer system described herein. It is to be understood that an individual might perform more than one of these roles for a particular event.

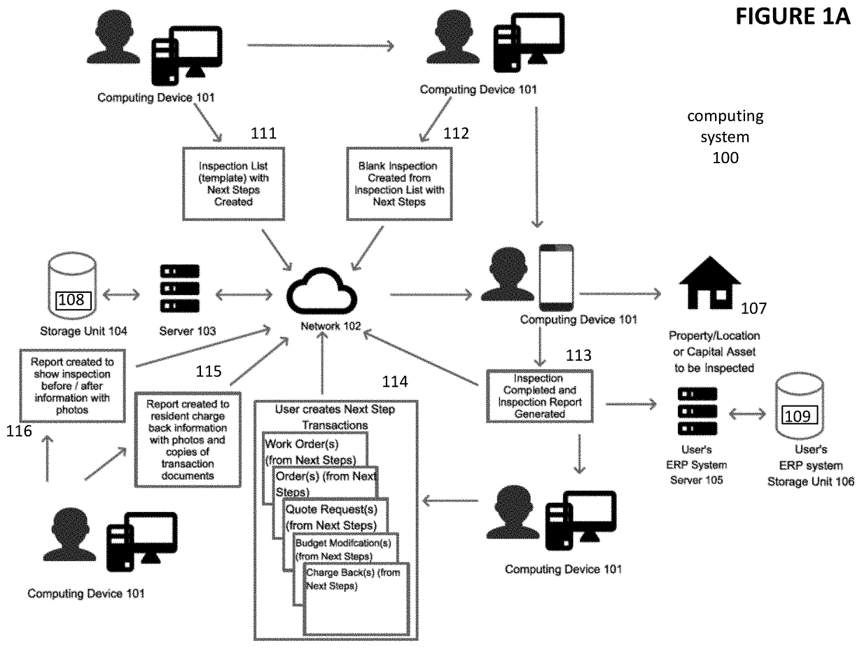

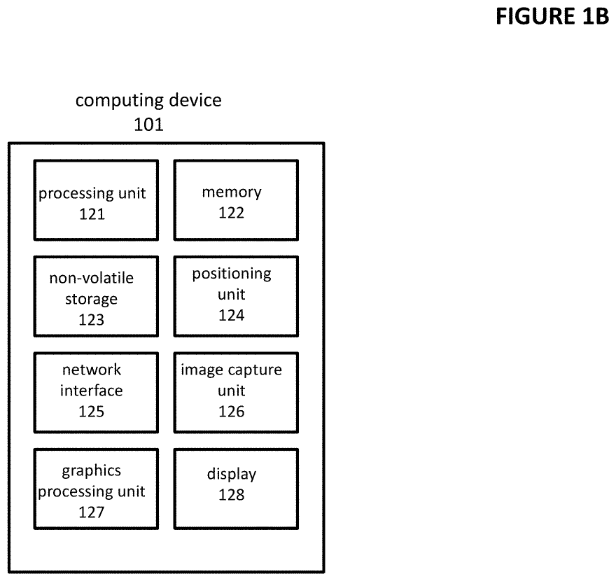

FIG. 1A depicts computer system 100. Computer system 100 comprises a plurality of computing devices 101, network 102, server 103, storage unit 104 for server 103, ERP system server 105, and storage system 106 for ERP system server 105.

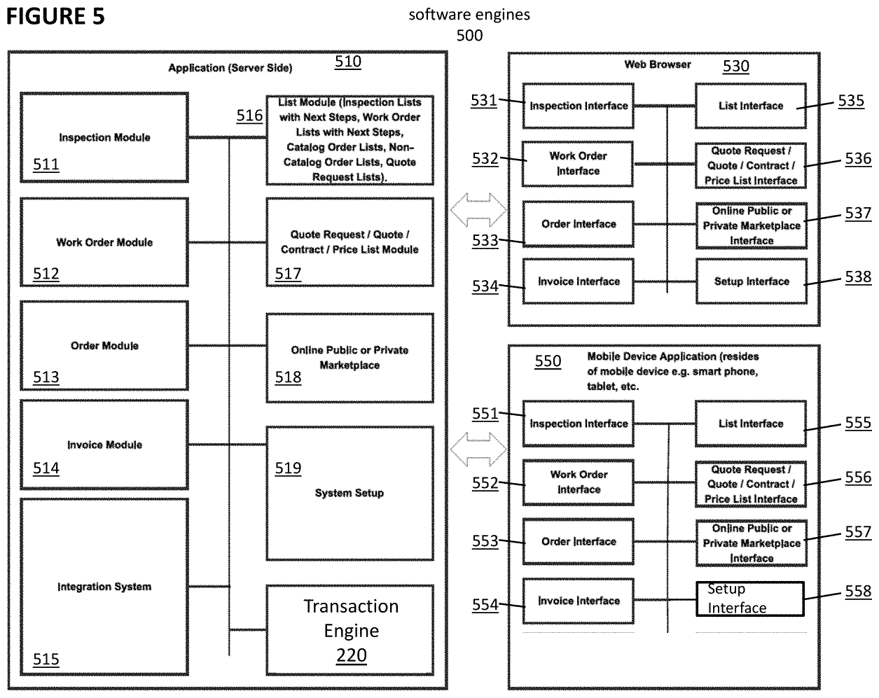

In the typical operation of computer system 100, a computing device 101 is used to generate an inspection list, which is a template, with work performance transactions created (step 111). The same or a different computing device 101 is used to create a blank inspection using the inspection list with work performance transactions (step 112). The same or different computing device 101 is then used by an inspector during an inspection of property or building 107 to complete the inspection and generate an inspection report (step 113). A computing device 101 is then used to create work performance transactions, such as generating a work order, generating an order, issuing a quote request, issuing a modified budget, or sending a charge back for the work performance transactions (step 114). A computing device 101 is then used to create a report to resident charge back information with photos and copies of transaction documents (step 115), and to create a report to show inspection before/after information with photos (step 116). Data generated during this process can be stored by server 103 in storage unit 104 (optionally, in database 108 stored in storage unit 104) or by ERP system server 105 in SRP system storage unit 106 (optionally, in database 109 stored in storage unit 106). The steps depicted in FIG. 1A are executed by one or more of the software engines 500 depicted in FIG. 5, discussed below.

FIG. 1B depicts hardware components of each computing device 101. Computing device 101 can be a server, notebook computer, desktop computer, tablet, smartphone, gaming unit, wearable computing device such as a watch or glasses, or any other computing device.

Computing device 101 comprises processing unit 121, memory 122, non-volatile storage 123, positioning unit 124, network interface 125, image capture unit 126, graphics processing unit 127, and display 128.

Processing unit 121 optionally comprises a microprocessor with one or more processing cores. Memory 122 optionally comprises DRAM or SRAM volatile memory. Non-volatile storage 123 optionally comprises a hard disk drive or flash memory array. Positioning unit 124 optionally comprises a GPS unit or GNSS unit that communicates with GPS or GNSS satellites to determine latitude and longitude coordinates for client device 100, usually output as latitude data and longitude data. Network interface 125 optionally comprises a wired interface (e.g., Ethernet interface) or wireless interface (e.g., 3G, 4G, 5G, GSM, 802.11, protocol known by the trademark BLUETOOTH, etc.). Image capture unit 126 optionally comprises one or more standard cameras (as is currently found on most smartphones and notebook computers) to capture still images or video. Graphics processing unit 127 optionally comprises a controller or processor for generating graphics for display. Display 128 displays the graphics generated by graphics processing unit 127, and optionally comprises a monitor, touchscreen, or other type of display.

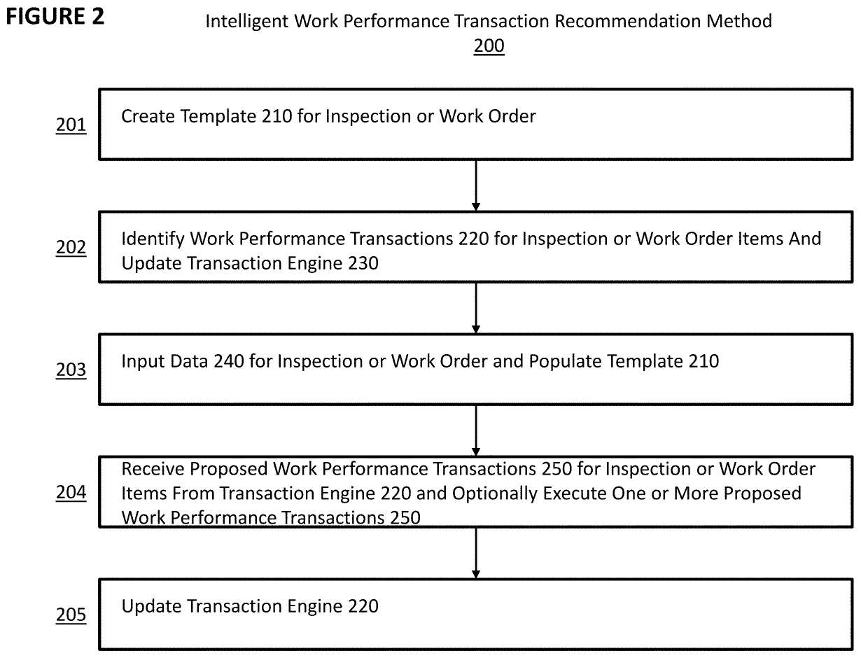

FIG. 2 depicts intelligent work performance transaction recommendation method 200 that can be performed by computer system 100.

In step 201, an inspector or contractor creates template 210 for an inspection or work order. Template 210 includes inspection or work order items which can be defined by room, category, instructions, and user defined inputs (text fields, defined lists, etc.). Optionally, step 201 further comprises a user customizing template 210 for use in a specific building.

In step 202, the user identifies potential work performance transactions 220 for an inspection or work order and updates transaction engine 230.

In step 203, an inspector performs an inspection and inputs data 240 from the inspection to populate template 210, or a contractor inputs data 240 into a work order to populate template 210. The data 240 can include ratings, statuses, instructions, notes, messages to and from other parties, financial information, custom field data, photos and videos and all related transaction line items (from orders, quote requests, work orders, and budgets) relevant to the inspection and work order line items.

In step 204, the inspector or contractor receives proposed work performance transactions 250 for the inspection or work order, respectively, from transaction engine 230 and optionally executes one or more of the proposed work performance transactions 250. Examples of proposed work performance transactions 250 include requesting a product or service from a supplier, requesting a price and delivery date quote for a product or service from a supplier, scheduling an appointment with a supplier or contractor, generating a new budget, and other actions.

In step 205, the transaction engine is updated to reflect the one or more of the proposed work performance transactions 250 that were performed, which will allow it to further refine its proposed work performance transactions for future inspections or work orders. For example, characteristics of the inspection or work order and the work performance transactions that were selected and performed in conjunction with the inspection or work order can be identified and stored.

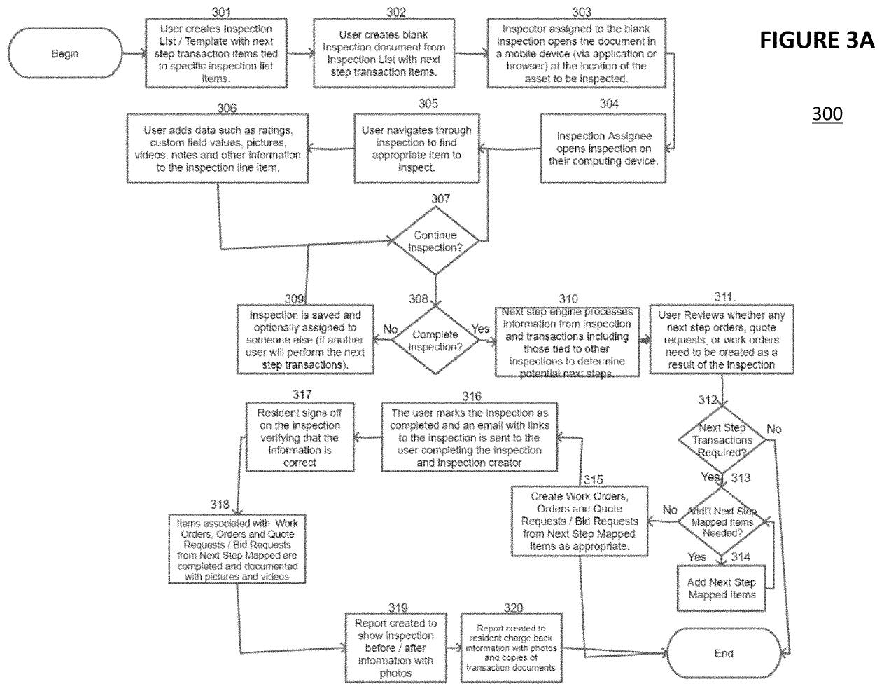

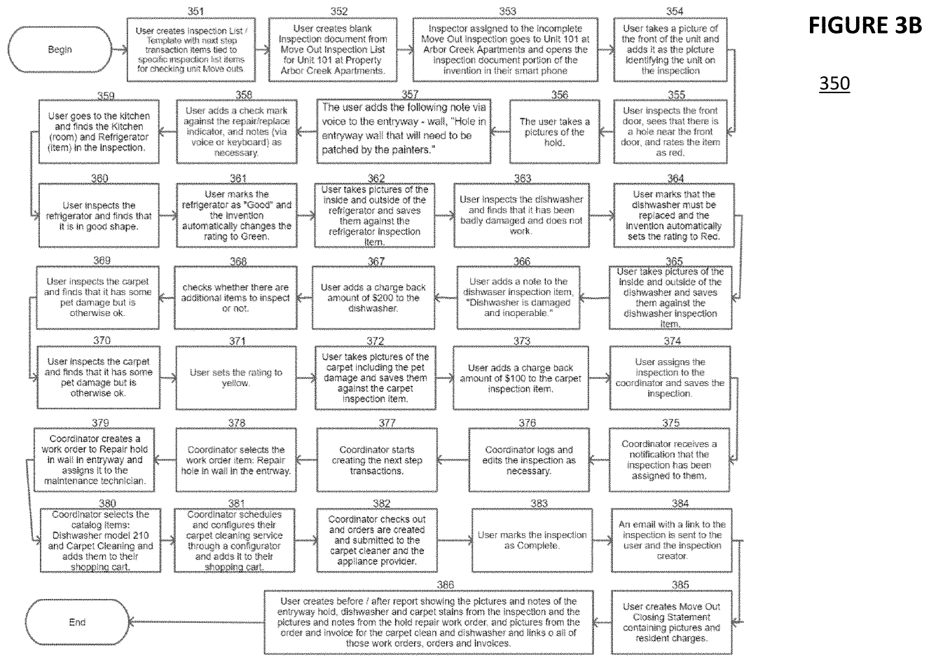

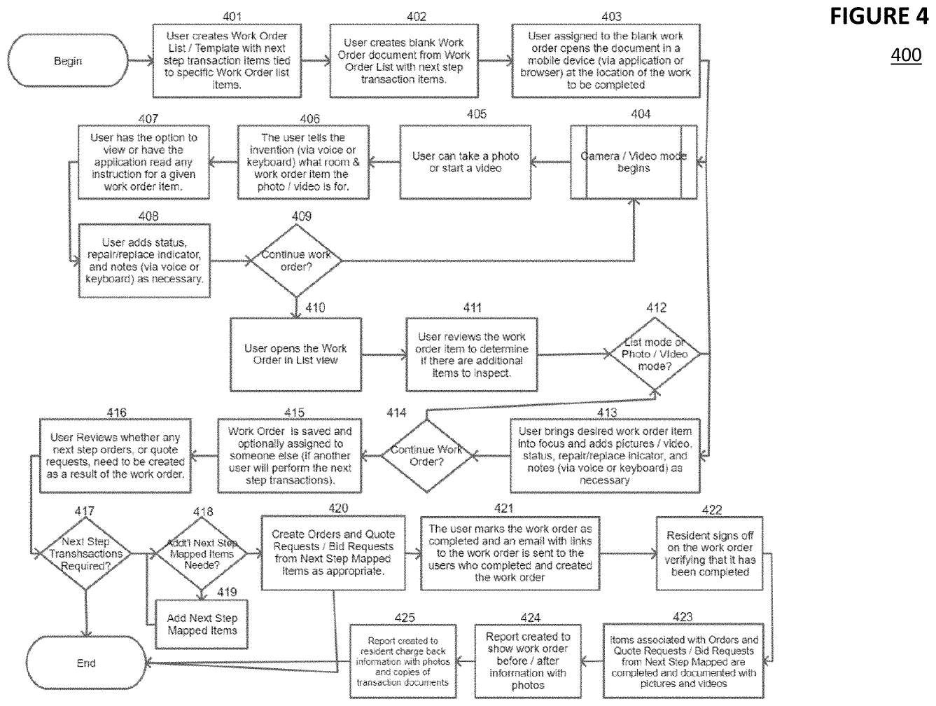

FIGS. 3A, 3B, and 4 depict examples of implementations of computer system 100 performing intelligent work performance transaction recommendation method 200 in various scenarios.

FIG. 3A depicts exemplary process flow 300 for handling a building inspection during a construction process using computer system 100 from FIG. 1, which is a variation of intelligent work performance transaction recommendation method 200 in FIG. 2.

In step 301, a user creates a template containing a set of inspection items to be used to prepare future inspection documents. Inspection line items contain the inspection item, the areas/rooms against which the item will be created, the category of the item, and any instructions that should be included with the item within an inspection.

In step 302, a user sets up an inspection data structure from an inspection template. The complete set of items or a subset of items from the template are added to the inspection data structure as inspection items. For any defined areas/rooms for inspection items from the list that exist within the property or location for which the inspection data structure is being created, those areas/rooms are defined within the inspection item on the newly created inspection. Instructions and categories are also populated on the inspection items created from the template/list items if defined.

In step 303, the inspector opens the inspection data structure in a computing device, typically a mobile device, at the location to be inspected.

In step 304, the inspector opens the inspection data structure on his or her computing device 101.

In step 305, the inspector indicates on his computing device 101 the invention which specific rooms/area on which they will be inspecting.

In step 306, the inspector indicates on his computing device 101 the invention which specific inspection items they will be inspecting.

In step 307, the inspector can have the computing device 101 audibly provide any instructions for the inspection item or display the instructions on the screen.

In step 308, the inspector adds the status of the inspection item, defines whether the item should be repaired or replaced, and records any notes via the keyboard or through voice transcription.

In step 309, the inspector reviews the list of inspection items to determine if there are any additional items left to inspect.

In step 310, the inspector can assign the inspection to another user.

In step 311, the user that is assigned the inspection can review whether any work performance orders, quote requests, work orders or budget updates need to be created as a result of the items within the inspection. Work performance order, quote request, work order or budget items can be pre-mapped to inspection items in the list/template from which the inspection was created or can be added ad-hoc to inspection items.

In step 312, the user decides whether to process any work performance transactions. If so, they progress to step 313 to determine whether they add any ad-hoc work performance items to any particular inspection items.

In step 313, the user adds additional work performance work order, order, quote request and/or budget items to specific inspection items as needed.

In step 314, the user determines whether to create work performance transactions or not.

In step 315, the user creates work orders, orders, and quote requests or modifies the location's budget based upon the chosen work performance items they wish to process into transactions. As they process transactions with work performance items, the work performance items are removed from the inspection.

In step 316, the user marks the inspection as completed. As a result of this, both the user completing the inspection and the user that created the inspection receive an email notifying them of the completion of the inspection with links to download a copy of the completed inspection.

In step 317, the resident signs the inspection to acknowledge that the information on the inspection is accurate.

In step 318, the work performance transactions associated with the inspection are completed and are documented with notes and pictures.

In step 319, the user runs a report that will show them before and after information from the inspection. This will include before pictures and notes of items in the inspection and pictures of completed work as well as items from work performance transactions which document the after associated with the inspection items.

In step 320, the user creates a report to document items and amounts for which they intend to charge residents for damage to the property. The report contains the charge back amounts, the line item, notes and pictures related to the charge back amount and a copy of the document (e.g. the inspection, order, quote request, quote, contract, invoice, or work order) that is the source of the charge to the resident.

FIG. 3B depicts an exemplary process flow 350 for handling an inspection of a property after a tenant has moved out of a building, using computer system 100 from FIG. 1, which is a variation of intelligent work performance transaction recommendation method 200 in FIG. 2.

In step 351, a user creates an inspection template with work performance transaction items tied to specific inspection list items for a move-out.

In step 352, the user creates a blank inspection document using the move-out inspection template for Unit 101 at Property Arbor Creek Apartments.

In step 353, an inspector assigned to the incomplete the move-out inspection goes to Unit 101 at Arbor Creek Apartments and opens the inspection document using an application or web browser in his or her computing device 101, such as a smartphone.

In step 354, the inspector takes a picture of the front of the unit and adds it as the picture identifying the unit on the inspection

In step 355, the inspector inspects the front door, sees that there is a hole near the front door, and rates the item as “red.”

In step 356, the inspector takes a pictures of the hole.

In step 357, the user adds the following note using a voice interface of the computing device 101 to the entryway-wall item: “Hole in entryway wall that will need to be patched by the painters.”

In step 358, the inspector adds a check mark against the repair/replace indicator, and makes a note as needed.

In step 359, the inspector goes to the kitchen and finds the Kitchen (room) and Refrigerator (item) in the template.

In step 360, the inspector inspects the refrigerator and finds that it is in good shape.

In step 361, the inspector marks the refrigerator as “Good” and the computing device 101 automatically changes the rating to “green.”

In step 362, the inspector takes photos of the inside and outside of the refrigerator and saves them against the refrigerator inspection item.

In step 363, the inspector inspects the dishwasher and finds that it has been badly damaged and does not work.

In step 364, the inspector marks that the dishwasher must be replaced and computing device 101 automatically sets the rating to “red.”

In step 365, the inspector takes photos of the inside and outside of the dishwasher and saves them against the dishwasher inspection item.

In step 366, the inspector adds a note to the dishwasher inspection item, “Dishwasher is damaged and inoperable.”

In step 367, the inspector adds a charge back amount of $200 to the dishwasher.

In step 368, the inspector checks whether there are additional items to inspect or not.

In step 369, the inspector inspects the carpet and finds that it has some pet damage but is otherwise ok.

In step 370, the inspector inspects the carpet and finds that it has some pet damage but is otherwise ok.

In step 371, the inspector sets the rating to “yellow.”

In step 372, the inspector takes pictures of the carpet including the pet damage and saves them against the carpet inspection item.

In step 373, the inspector adds a charge back amount of $100 to the carpet inspection item.

In step 374, the inspector assigns the inspection to the coordinator and saves the inspection.

In step 375, the coordinator receives a notification that the inspection has been assigned to him or her.

In step 376, the coordinator logs and edits the inspection as necessary.

In step 377, the coordinator starts creating the work performance transactions.

In step 378, the coordinator selects the work order item: “Repair hole in wall in the entryway.”

In step 379, the coordinator creates a work order to repair the hole in wall in entryway and assigns it to the maintenance technician.

In step 380, the coordinator selects the catalog items: “Dishwasher model 210” and “Carpet Cleaning” and adds them to their shopping cart.

In step 381, the coordinator schedules and configures the carpet cleaning service through a configurator and adds it to his or her shopping cart.

In step 382, the coordinator checks out and orders are created and submitted to the carpet cleaner and the appliance provider.

In step 383, the inspector or coordinator marks the inspection as “complete.”

In step 384, an email with a link to the inspection report is sent to the owner, the tenant, the inspector, the coordinator, and other interested persons.

In step 385, the inspector or coordinator creates a Move Out Closing Statement containing pictures and resident charges.

In step 386, the inspector or coordinator creates a “before and after” report showing the pictures and notes of the entryway hold, dishwasher and carpet stains from the inspection and the pictures and notes from the hold repair work order, and pictures from the order and invoice for the carpet dean and dishwasher and links to all of those work orders, orders and invoices.

FIG. 4 depicts exemplary process flow 400 for handling work orders using computer system 100 of FIG. 1.

In step 401, a user creates a work order template with work performance transaction items tied to specific work order items.

In step 402, a user creates a blank work order data structure using the work order template and work performance transaction items.

In step 403, a contractor opens blank work order data structure in a computing device 101 (via application or browser) at the location of the work to be completed

In step 404, the contractor starts camera/video mode on the computing device 101.

In step 405, the contractor starts to take a photo or video.

In step 406, the contractor tells computing device 101 what room and work order item the photo or video is for.

In step 407, the contractor has the option to view or have the application read any instruction for a given work order item.

In step 408, the contractor adds status, repair/replace indicator, and notes (via voice or keyboard) as necessary.

In step 409, the computing device 101 asks the contractor whether he or she wishes to continue the work order.

In step 410, the contractor opens the work order in List view

In step 411, the contractor reviews the work order item to determine if there are additional items to inspect.

In step 412, computing device 101 asks the contractor whether he or she wishes to proceed in List mode or Photo/Video mode?

In step 413, the contractor brings the desired work order item into focus and adds photos/video, status, repair/replace indicator, and notes (via voice or keyboard) as necessary

In step 414, computing device 101 asks the contractor if he or she wishes to continue the work order.

In step 415, the work order is saved and optionally assigned to someone else (if another user will perform the work performance transactions).

In step 416, the contractor or another user reviews whether any work performance orders, or quote requests, need to be created as a result of the work order.

In step 417, the computing device 101 asks the contractor or user whether work performance transactions are required.

In step 418, the computing device 101 asks the contractor or user whether additional work performance transactions are needed.

In step 419, the contractor user adds work performance transactions.

In step 420, computing device 101 creates orders, quote requests, bid requests, or takes other action based on the work performance transactions.

In step 421, the contractor or user marks the work order as completed and an email with links to the work order is sent to the contractor, owner, coordinator, and all other interested users.

In step 422, the tenant or owner signs off on the work order verifying that it has been completed

In step 423, items associated with work perform transactions, such as orders, quote requests, and bid requests are completed and documented with pictures and videos

In step 424, computing device 101 generates a report showing the property before and after the work order is performed, including photos or video.

In step 425, computing device 101 generates a report and sends charge back information to the owner or tenant, including photos and copies of transaction documents.

FIG. 5 depicts software engines 500 that are operated by computing devices 101 and server 103 in computing system 100. Software engines 500 comprise lines of code executed by processing unit 121 in computing devices 101 and server 103. Software engines 500 comprise server engine 510, web browser engine 530, and client engine 550.

Server engine 510 is executed by server 103 and comprises the modules described in Table 1:

TABLE 1
Modules in Server Engine 510

| Name of Module | Function |
|---|---|
| Inspection Module 511 | Generates user interface for inspection |
| Work Order Module 512 | Generates user interface for work order |
| Order Module 513 | Performs orders |
| Invoice Module 514 | Generates invoices |
| Integration System 515 | Manages communication between |
| | different computing devices 101 |
| List Module 516 | Manages templates 210 |
| Quote request/quote/contract/ | Manages pricing and quantity |
| price list module 517 | information for work performance |
| | transactions 220 |
| Online Public or Private | Obtains data from online marketplaces |
| Marketplace 518 | |
| System Setup 519 | Allows user to configure system |
| Transaction Engine 220 | Provides proposed work performance |
| | transaction 250 |

Web browser engine 530 is executed by computing device 101 and comprises the modules described in Table 2 which generate a web interface with which a user can interact:

TABLE 2
Modules in Computing Device 101

| Name of Module | Function |
|---|---|
| Inspection Interface 531 | Generates user interface for inspection |
| Work Order Interface 532 | Generates user interface for work order |
| Order Interface 533 | Generates user interface for order |
| Invoice Interface 534 | Generates user interface for invoice |
| List Interface 535 | Generates a template |
| Quote request/quote/contract/ | Manages pricing and quantity |
| price list interface 536 | information for work performance |
| | transactions 220 |
| Online public or private | Interacts with online marketplaces |
| marketplace interface 537 | |
| Setup interface 538 | Allows a user to configure the system |

Client Engine 550 is executed by computing device 101 and comprises the modules described in Table 3 which generate a web interface or mobile app with which a user can interact without the user of web browser 530:

TABLE 3
Modules in Computing Device 101

| Name of Module | Function |
|---|---|
| Inspection Interface 551 | Generates user interface for inspection |
| Work Order Interface 552 | Generates user interface for work order |
| Order Interface 553 | Generates user interface for order |
| Invoice Interface 554 | Generates user interface for invoice |
| List Interface 555 | Generates a template |
| Quote request/quote/contract/ | Manages pricing and quantity |
| price list interface 556 | information for work performance |
| | transactions 220 |
| Online public or private | Interacts with online marketplaces |
| marketplace interface 557 | |
| Setup interface 558 | Allows a user to configure the system |

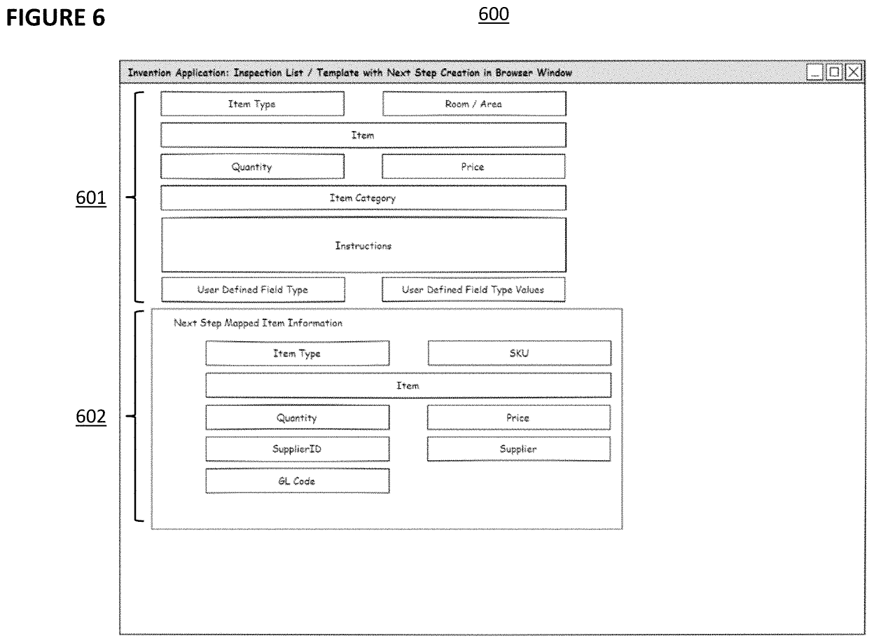

FIG. 6 depicts a screenshot of exemplary user interface 600 for creating an inspection list item with a mapped work performance. User interface 600 comprises input fields 601 and input fields 602. User interface 600 can be used in steps 301-302 of FIG. 3A.

Input fields 601 receive input from the inspector regarding items that require repair or replacement. Input fields 601 include interfaces to receive input regarding item type, room/area, item, quantity, price, item category, instructions, user defined field type, and user defined field type values

Input fields 602 receive input from the inspector regarding work performances for organizing and performing the repair or replacement action. Input fields 602 include interfaces to receive input regarding item type, SKU, item, quantity, price, supplier ID, supplier, and GL code. Optionally, when an inspector selects one of input fields 602, available options will be displayed. For example, selecting the SKU field might cause the display to show SKUs for available items that would be appropriate for the repair or replacement in question.

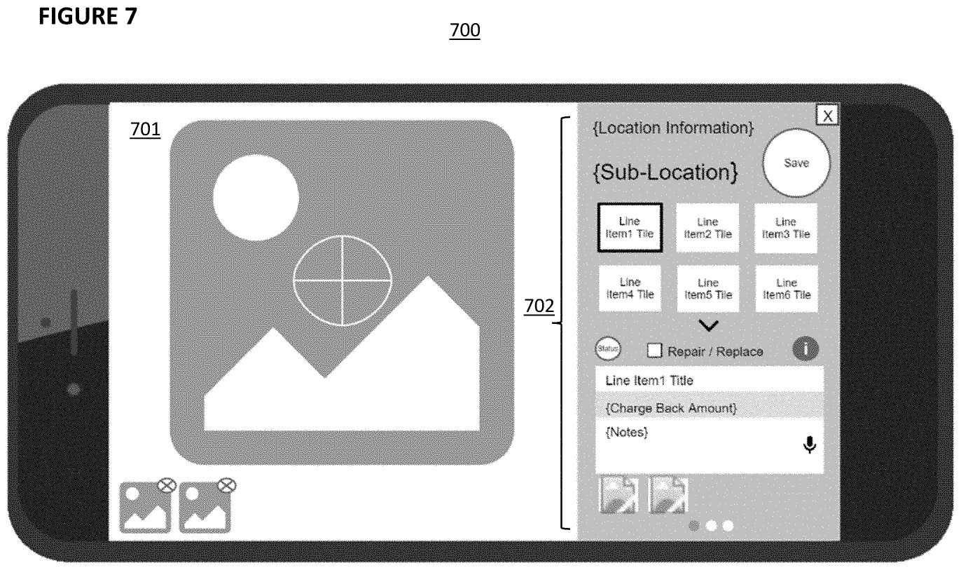

FIG. 7 depicts a screenshot of exemplary user interface 700 for a video-centric inspection mode. User interface 700 comprises photo field 701 that allows the inspector to take a photo of the room or area being inspected, and input fields 702 that allows the inspector to input information about the item that is being noted in the inspection report. User interface 700 can be used, for example, in steps 303 to 309 of FIG. 3A.

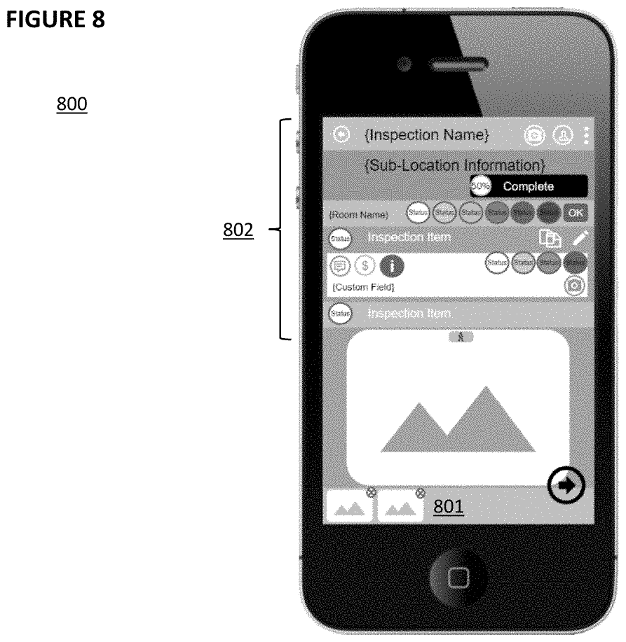

FIG. 8 depicts a screenshot of exemplary user interface 800 for a list view inspection mode. User interface 800 comprises photo field 801 that allows the inspector to take a photo of the room or area being inspected, and input fields 802 that allows the inspector to input information about the item that is being noted in the inspection report. User interface 800 can be used, for example, in steps 303 to 309 of FIG. 3A.

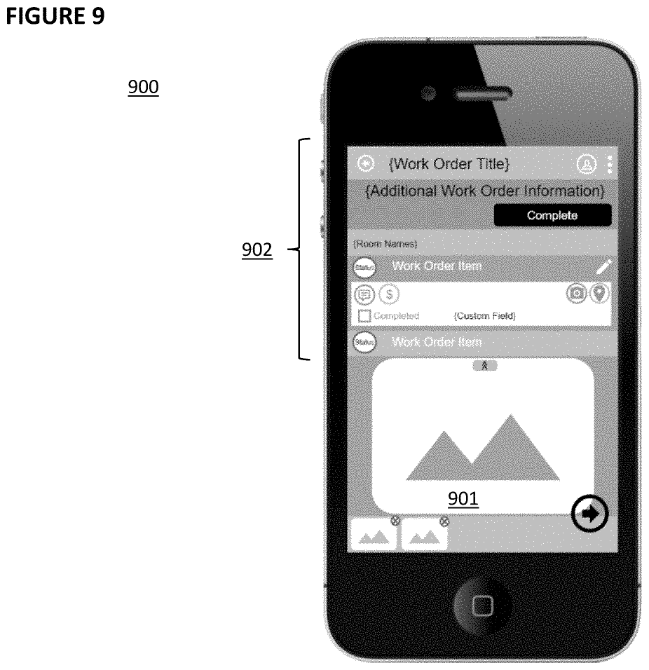

FIG. 9 depicts screenshot of exemplary user interface 900 for a list view work order mode. User interface 900 comprises photo field 901 that allows the inspector to take a photo of the room or area being inspected, and input fields 902 that allows the inspector to input information about the item for which a work order is being prepared. User interface 500 can be used, for example, in steps 404 to 415 of FIG. 4.

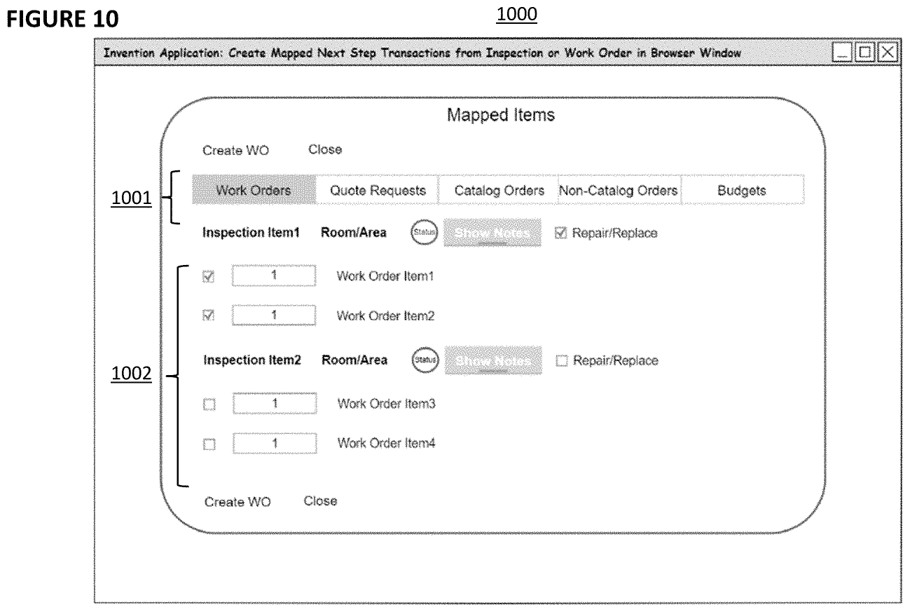

FIG. 10 depicts screenshot of exemplary user interface 1000 for creating mapped work performance transactions. User interface 1000 comprises input fields 1001 and input fields 1002. User interface 500 can be used, for example, in steps 311 to 315 of FIG. 3A.

Input fields 1001 allow the inspector to select an entry mode: work orders, quote requests, catalog orders, non-catalog orders, and budgets. Here, the work order mode is selected.

Input fields 1002 receive input from the inspector regarding work performances for organizing and performing the repair or replacement action. Input fields 1002 include interfaces to receive instructions to purchase particular items from particular sources.

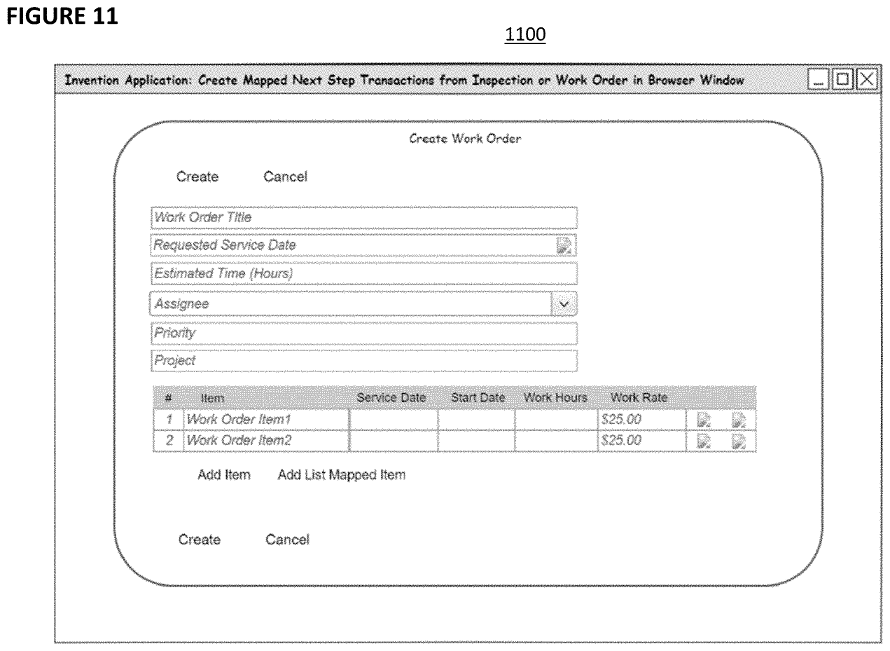

FIG. 11 depicts screenshot of exemplary user interface 1100 that provides additional options for the mapped work performance transactions shown in FIG. 10. Here, if a user selects a particular item in user interface 1000, then user interface 1100 will display purchasing information for that item, include supplier names, product images, product names, SKU, category, quantity, and price. User interface 1100 can be used, for example, in steps 311 to 315 of FIG. 3A.

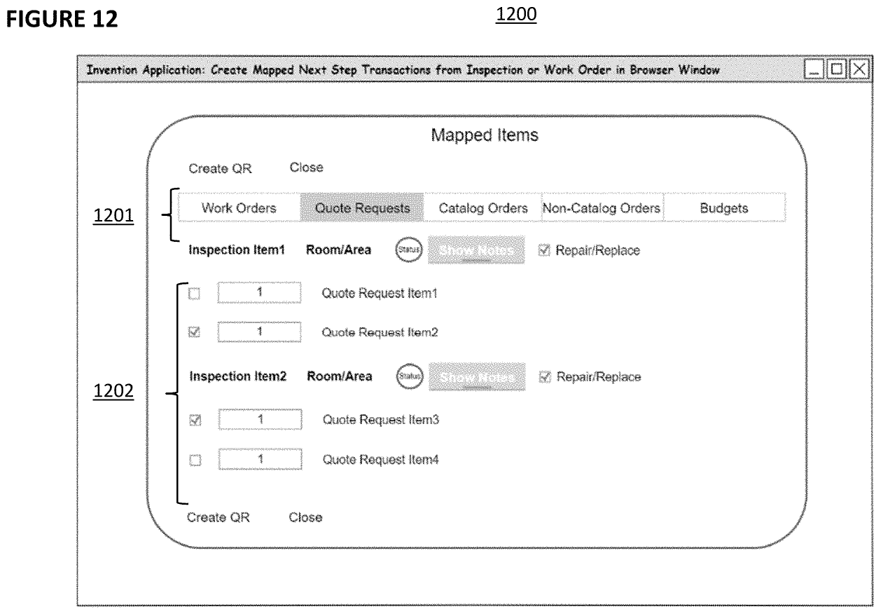

FIG. 12 depicts screenshot of exemplary user interface 1200 for creating mapped work performance transactions. User interface 1200 comprises input fields 1201 and input fields 1202. User interface 1200 can be used, for example, in steps 311 to 315 of FIG. 3A.

Input fields 1201 allow the inspector to select an entry mode: work orders, quote requests, catalog orders, non-catalog orders, and budgets. Here, the quote requests mode is selected.

Input fields 1202 receive input from the inspector regarding work performances for organizing and performing the repair or replacement action. Input fields 1202 include interfaces to receive instructions to purchase particular items from particular sources.

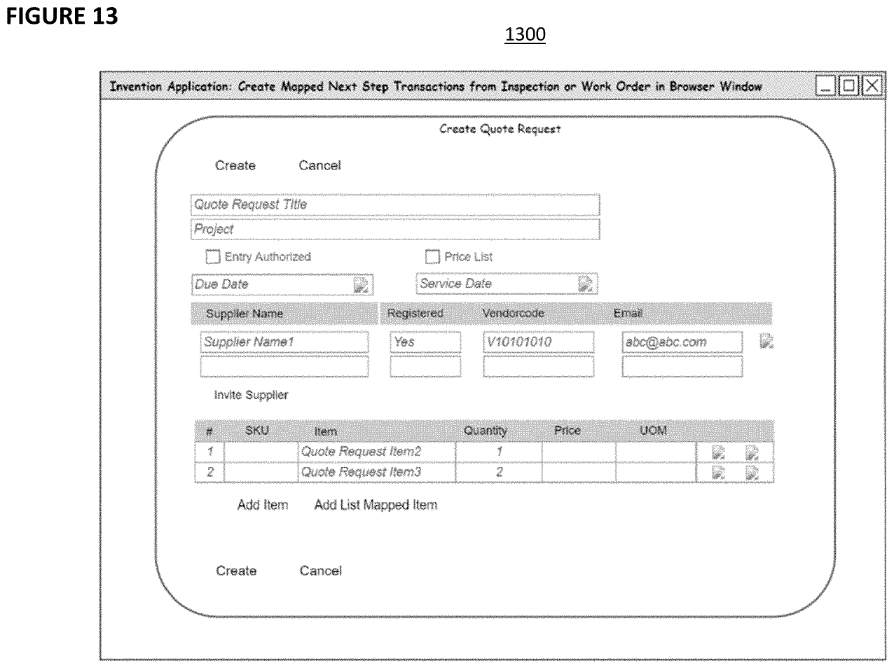

FIG. 13 depicts screenshot of exemplary user interface 1300 that provides additional options for the mapped work performance transactions shown in FIG. 12. Here, if a user selects a particular item in user interface 1200, then user interface 1300 will display purchasing information for that item, include supplier names, product images, product names, SKU, category, quantity, and price. User interface 1300 can be used, for example, in steps 311 to 315 of FIG. 3A.

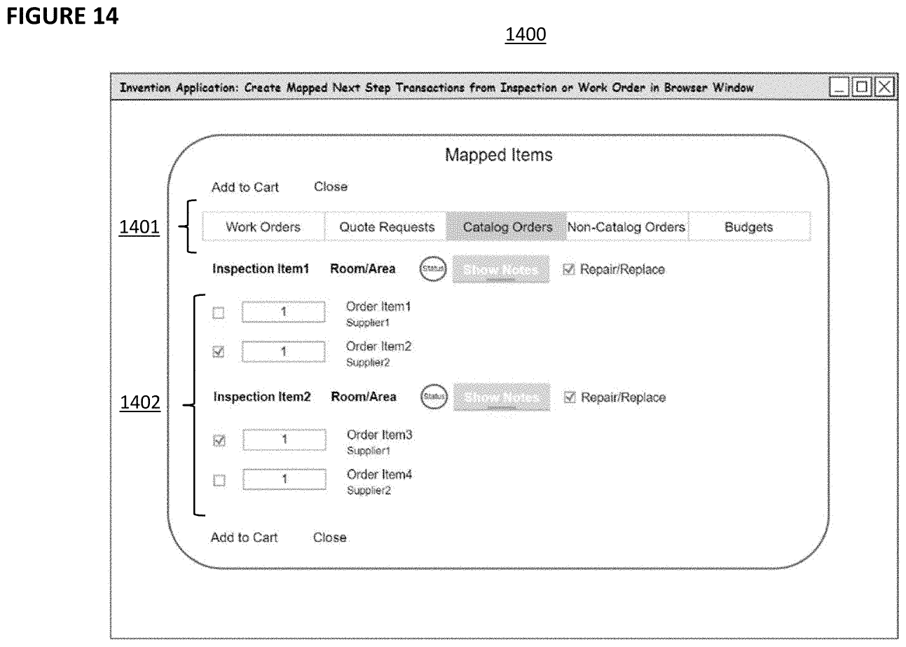

FIG. 14 depicts screenshot of exemplary user interface 1400 for creating mapped work performance transactions. User interface 1400 comprises input fields 1401 and input fields 1402. User interface 1400 can be used, for example, in steps 311 to 315 of FIG. 3A.

Input fields 1401 allow the inspector to select an entry mode: work orders, quote requests, catalog orders, non-catalog orders, and budgets. Here, catalog orders mode is selected.

Input fields 1402 receive input from the inspector regarding work performances for organizing and performing the repair or replacement action. Input fields 1402 include interfaces to receive instructions to purchase particular items from particular sources.

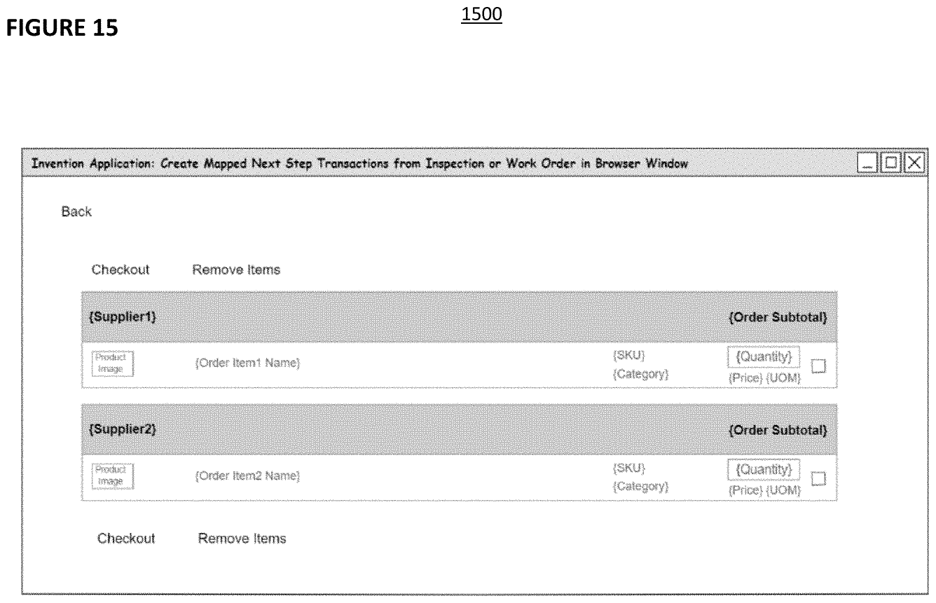

FIG. 15 depicts screenshot of exemplary user interface 1500 that provides additional options for the mapped work performance transactions shown in FIG. 14. Here, if a user selects a particular item in user interface 1400, then user interface 1500 will display purchasing information for that item, include supplier names, product images, product names, SKU, category, quantity, and price. User interface 1500 can be used, for example, in steps 311 to 315 of FIG. 3A.

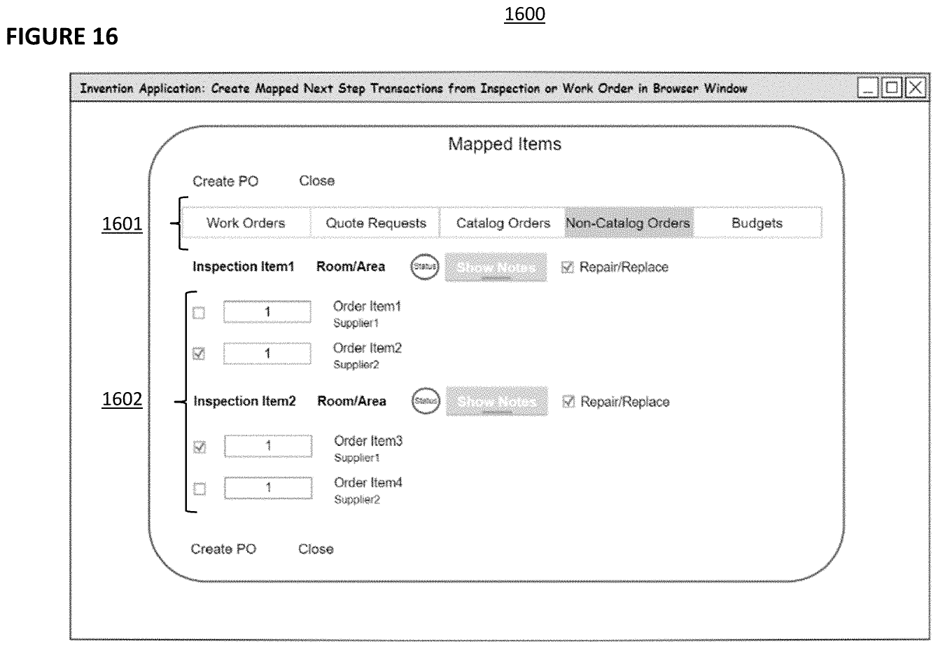

FIG. 16 depicts screenshot of exemplary user interface 1600 for creating mapped work performance transactions. User interface 1600 comprises input fields 1601 and input fields 1602. User interface 1600 can be used, for example, in steps 311 to 315 of FIG. 3A.

Input fields 1601 allow the inspector to select an entry mode: work orders, quote requests, catalog orders, non-catalog orders, and budgets. Here, non-catalog orders mode is selected.

Input fields 1602 receive input from the inspector regarding work performances for organizing and performing the repair or replacement action. Input fields 1502 include interfaces to receive instructions to purchase particular items from particular sources.

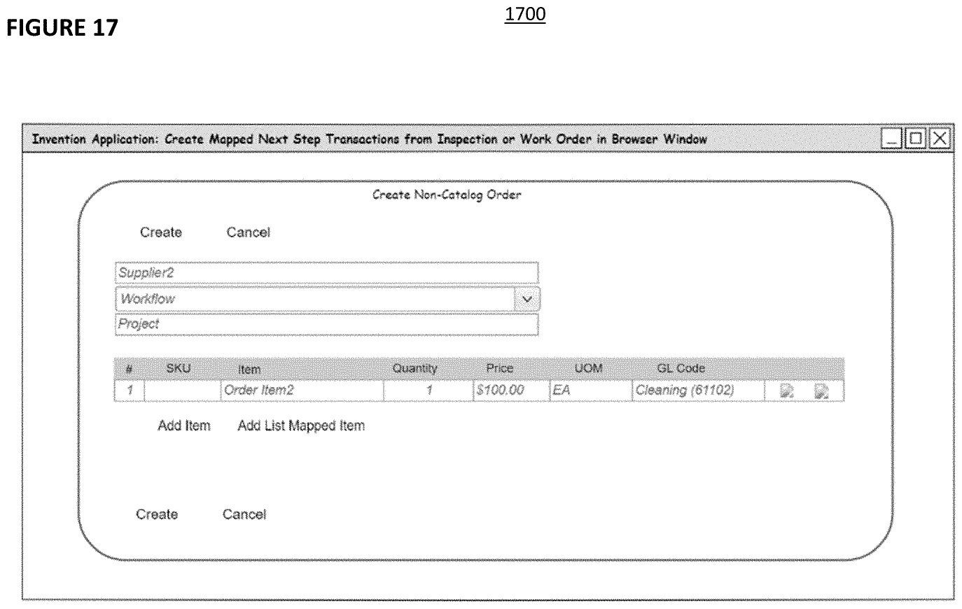

FIG. 17 depicts screenshot of exemplary user interface 1700 that provides additional options for the mapped work performance transactions shown in FIG. 16. Here, if a user selects a particular item in user interface 1600, then user interface 1700 will display purchasing information for that item, include supplier names, product images, product names, SKU, category, quantity, and price. User interface 1700 can be used, for example, in steps 311 to 315 of FIG. 3A.

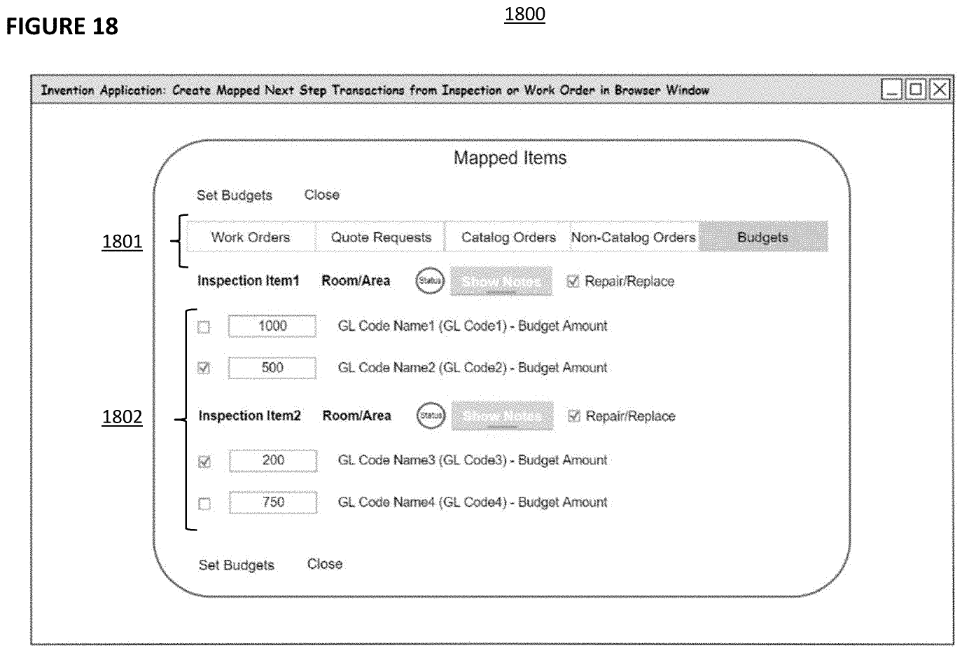

FIG. 18 depicts screenshot of exemplary user interface 1800 for creating mapped work performance transactions. User interface 1800 comprises input fields 1801 and input fields 1802. User interface 1800 can be used in steps 311 to 315 of FIG. 3A.

Input fields 1801 allow the inspector to select an entry mode: work orders, quote requests, catalog orders, non-catalog orders, and budgets. Here, budgets mode is selected.

Input fields 1802 receive input from the inspector regarding work performances for organizing and performing the repair or replacement action. Input fields 1802 include interfaces to receive instructions to purchase particular items from particular sources.

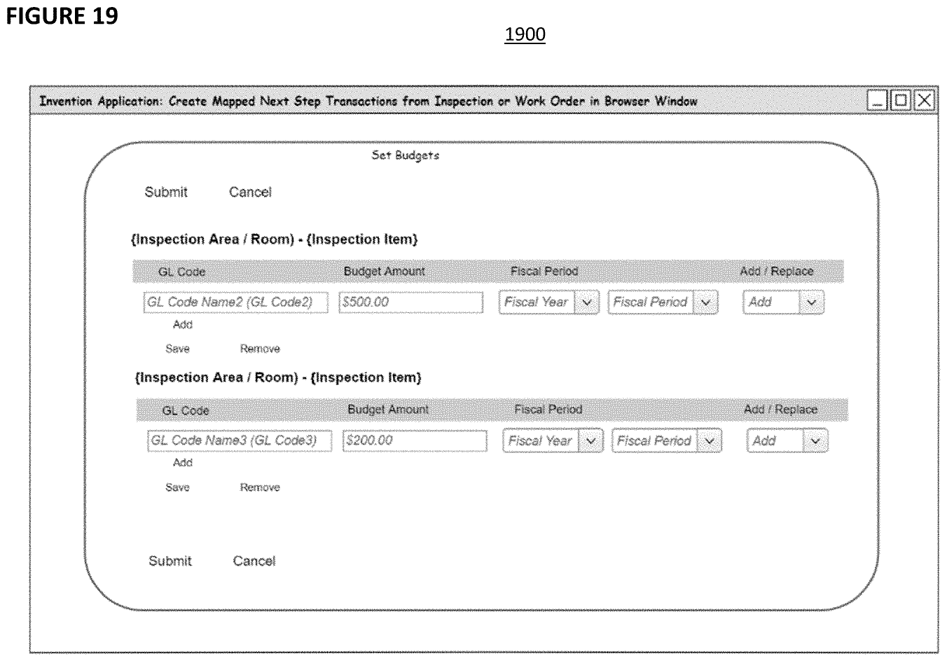

FIG. 19 depicts screenshot of exemplary user interface 1900 that provides additional options for the mapped work performance transactions shown in FIG. 18. Here, if a user selects a particular item in user interface 1800, then user interface 1900 will display purchasing information for that item, include supplier names, product images, product names, SKU, category, quantity, and price. User interface 1900 can be used, for example, in steps 311 to 315 of FIG. 3A.

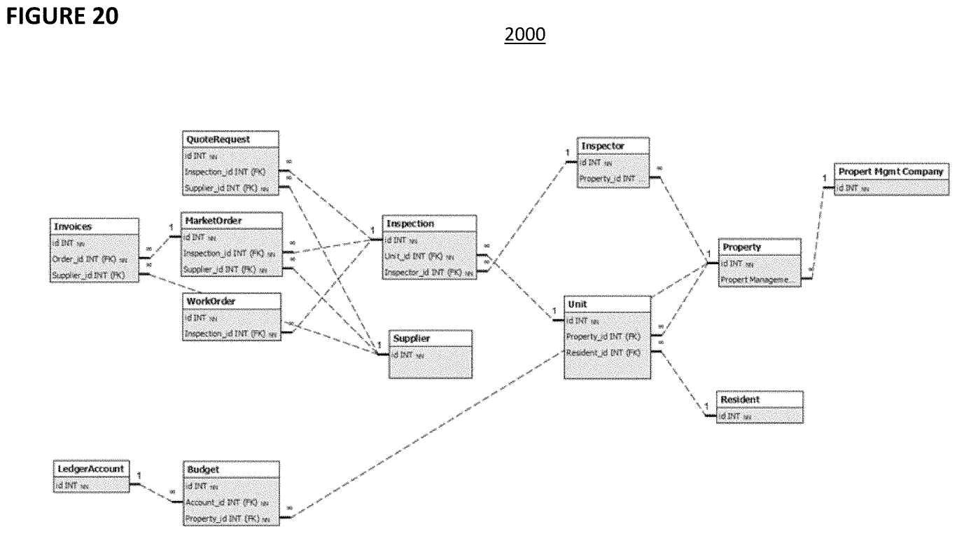

FIG. 20 depicts an exemplary database schema 2000 for a database that can be used to manage the data input in the user interfaces discussed above by server 103 or ERP server 105.

The resulting inspection with work performance transaction makes it possible to enforce standards and create greater efficiencies through the inspection process. It also creates efficiencies and reduces cost by enforcing the electronic purchasing of products and services at pre-negotiated prices from specific suppliers, if defined. In addition, it can also streamline the process by which quote requests are generated, items on which residents should be assessed a charge and/or items on which budgets should be modified.

Additional methods can be used to recognize rooms/areas and inspections items based upon the photo/video information being input.

Additional methods can be used to predict the work performances transaction items that the user may want to pursue as a result of what they found in the inspection.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

It is to be understood that the present invention is not limited to the embodiment(s) described above and illustrated herein but encompasses any and all variations evident from the above description. For example, references to the present invention herein are not intended to limit the scope of any claim or claim term, but instead merely make reference to one or more features that may be eventually covered by one or more claims.

What is claimed is:

1. A method of automating transactions for work performance on a building, comprising:
creating, by a computer system, a template;
customizing, using the computer system, the template for the building to generate a customized template;
populating, by the computer system, the customized template with input data provided by a user for the building;
recommending, by the computer system, a work performance transaction based on the input data; and
executing, using the computer system, the work performance transaction.

2. The method of claim 1, wherein the template comprises items for an inspection of the building.

3. The method of claim 1, wherein the template comprises items for a work order for the building.

4. The method of claim 1, wherein the work performance transaction comprises sending a request for a quote to a supplier.

5. The method of claim 1, wherein the work performance transaction comprises ordering a part of service from a supplier.

6. The method of claim 1, wherein the work performance transaction comprises scheduling an appointment at the building.

7. The method of claim 1, further comprising:
generating a budget.

8. The method of claim 1, further comprising:
determining the work performance transaction using an artificial intelligence engine and the input data.

9. The method of claim 1, further comprising:
determining one or more skills required by the customized template;
identifying a plurality of professionals who possess the one or more skills; and
providing the customized template to a selected professional from the plurality of professionals based on one or more criteria.

10. The method of claim 9, wherein the one or more criteria comprise one or more of the one or more skills.

11. The method of claim 9, wherein the one or more criteria comprise driving distance for each professional to the building.

12. The method of claim 9, wherein the one or more criteria comprise time availability of each professional.

13. The method of claim 9, wherein the one or more criteria comprise route optimization.

14. A method of automating transactions for work performance on a building, comprising:
obtaining, by a computing device, images or video of a building;
obtaining, by the computing device, notes from a user regarding the images or video;
populating, by the computing device, a template using the notes;
recommending, by the computing device, a work performance transaction in response to the notes; and
executing, by the computing device, at least part of the work performance transaction.

15. The method of claim 14, wherein the notes are provided by a user using text input.

16. The method of claim 14, wherein the notes are provided by a user using voice input.

17. A computing device for identifying automating a work performance transactions for a building, comprising:
a processing unit;
an input device; and
non-volatile storage containing a template for a building and instructions to be executed by the processing unit to perform the following steps:
populate the template with input data received with the input device from a user;
identify a work performance transaction based on the input data; and
execute the work performance transaction.

18. The computing device of claim 17, wherein the template comprises items for an inspection of the building.

19. The computing device of claim 17, wherein the template comprises items for a work order for the building.

20. The computing device of claim 17, wherein the work performance transaction comprises sending a request for a quote to a supplier.

21. The computing device of claim 17, wherein the work performance transaction comprises ordering a part or service from a supplier.

22. The computing device of claim 17, wherein the work performance transaction comprises scheduling an appointment at the building.

23. The computing device of claim 17, wherein the input device comprises a touchscreen.

24. The computing device of claim 17, wherein the input device comprises a microphone.
